(19) United States
(12) Patent Application Publication
(10) Pub. No.: US 2026/0100604 A1
(43) Pub. Date: Apr. 9, 2026

(54) SELF-LEARNING ALGORITHMS DEPLOYED AT EDGE DEVICES

(71) Applicant: Itron, Inc., Liberty Lake, WA (US)

(72) Inventors: Meredith Gilstrap, Spokane, WA (US); Raj Vaswani, Portola Valley, CA (US); Elad Gottlib, San Ramon, CA (US); Jake Boyd, Gilroy, CA (US)

(21) Appl. No.: 19/346,370

(22) Filed: Sep. 30, 2025

Related U.S. Application Data
(60) Provisional application No. 63/703,788, filed on Oct. 4, 2024.

(51) Int. Cl. H02J 13/00; H02J 3/00; H02J 3/38

(52) U.S. Cl. CPC H02J 13/12; H02J 3/003; H02J 3/381; H02J 2101/24; H02J 2103/30

(57) ABSTRACT

The present disclosure provides systems and methods for managing electrical power distribution using artificial intelligence models deployed on edge computing devices positioned within power distribution environments. These edge devices may analyze measurement data from various sources throughout the electrical network and generate predictive forecasts to inform power management decisions. The edge computing device may coordinate with distributed generation systems to optimize electrical power management through localized control actions. The artificial intelligence model may process electrical consumption and generation data to generate forecasts of electrical demand and supply conditions.

### CROSS-REFERENCE TO RELATED APPLICATIONS

This application claims priority to U.S. Provisional Application No. 63/703,788, titled “Self-Learning Algorithms Deployed at Edge Devices,” filed October 4, 2024, which is hereby incorporated by reference in its entirety.

### FIELD OF INVENTION

The present disclosure relates to electrical supply and load management systems, and more particularly to methods, apparatus, and systems for adjusting electrical supply and/or load at an individual meter level or other edge device using self-learning algorithms based on demand forecasting.

### BACKGROUND

Demand for electricity changes throughout the day and across different seasons, creating complex patterns that challenge traditional power management approaches. The change in demand is driven by many factors including weather conditions, ambient temperature variations, the number and types of electricity consuming devices in operation, peak usage periods during morning and evening hours, and the increasing number of residential electricity generating devices such as rooftop solar installations and battery storage systems. Additionally, the growing adoption of electric vehicles and their charging requirements introduces new variables to electrical demand patterns. However, electricity supply does not always match the demand for electricity, particularly as renewable energy sources like solar and wind generation create intermittent supply conditions that may not align with peak consumption periods. This mismatch between supply and demand can result in grid instability, voltage fluctuations, equipment overloading, and increased operational costs for utility providers. Traditional centralized power management systems often struggle to respond quickly enough to these rapid changes in local electrical conditions, highlighting the need for more distributed and intelligent approaches to electrical grid management.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a power distribution environment with an edge device, according to aspects of the present disclosure.

FIG. 2 depicts the power distribution environment of FIG. 1 with distributed generation systems, according to an embodiment.

FIG. 3 shows a block diagram of the edge device of FIG. 1, according to aspects of the present disclosure.

FIG. 4 illustrates a flowchart of a method for implementing artificial intelligence-based electrical power management on an edge computing device, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Systems and methods for managing distribution of electrical power and loads using self-learning algorithms deployed at edge devices are disclosed. In some cases, electrical power distribution networks face challenges in balancing supply and demand due to fluctuating electricity consumption patterns throughout the day. These fluctuations may be driven by various factors including weather conditions, temperature variations, the number of electricity consuming devices in operation, and the presence of residential electricity generating devices. Traditional centralized power management systems may encounter limitations when attempting to respond to rapid changes in local electrical demand or supply conditions.

Edge computing devices equipped with artificial intelligence models may provide enhanced capabilities for managing electrical distribution at localized levels within power networks. In some cases, these edge devices may be positioned throughout electrical distribution systems to collect measurement data from various sources (e.g., electricity metering devices associated with the plurality of premises, a distributed generation system, electric vehicle telematics (e.g., technology that combines telecommunication and informatics to collect, analyze, and transmit data from vehicles and other assets) of an electric vehicle connected to an electrical grid, an electric vehicle supply equipment associated with the electrical grid, etc.) and make localized decisions regarding power management.

Edge computing devices equipped with artificial intelligence models may provide enhanced capabilities for managing electrical distribution at localized levels within power networks. In some cases, these edge devices may be positioned throughout electrical distribution systems to collect measurement data from various sources (e.g., electricity metering devices associated with the plurality of premises, a distributed generation system, electric vehicle telematics (e.g., technology that combines telecommunication and informatics to collect, analyze, and transmit data from vehicles and other assets) of an electric vehicle connected to an electrical grid, an electric vehicle supply equipment associated with the electrical grid, etc.) and make localized decisions regarding power management. The artificial intelligence models deployed on these edge devices, in which case the devices are said to be "host devices" for the models, may be configured to: (a) analyze measurement data from the host device and/or other devices communicating with the host device, (b) incorporate exogenous data including but not limited to grid topology information, grid behavior and performance models, physics models, weather and environmental model, etc., (c) generate predictions including but not limited to electrical demand and supply forecasts, modified versions of collected or received measurement data, grid device performance or behavior, etc., and (d) initiate appropriate control actions based on the analysis results.

In some cases, the control actions may include Load Management Actions, Electric Vehicle Charging Control (e.g., the edge device may adjust electric vehicle charging schedules by reducing charging load when predicted demand exceeds available supply and/or a predetermined threshold, or increasing charging load during periods of low demand or excess renewable generation), Battery Storage Operations (e.g., the system may direct battery storage systems to charge during periods of predicted low demand or high renewable generation, and discharge stored energy during predicted peak demand periods to support grid stability), Demand Response Activation (e.g., the edge device may trigger demand response programs by sending signals to participating customers to reduce non-essential electrical loads during forecasted peak demand periods), Generation Resource Coordination Distributed Generation Optimization, (e.g., the system may coordinate photovoltaic inverters to optimize power flow between solar generation, battery storage, local consumption, and grid export based on predicted supply and demand conditions), Reactive Power Management (e.g., the edge device may direct inverters to provide voltage support through reactive power injection during forecasted voltage sag conditions or periods of high electrical demand), Generation Curtailment (e.g., when excess generation is predicted, the system may reduce output from distributed renewable resources to prevent voltage rise or equipment overloading), Grid Support Functions Voltage Regulation (e.g., the edge device may coordinate multiple distributed resources to provide voltage support services when the forecast indicates potential voltage deviations from acceptable ranges), Frequency Response (e.g., the system may prepare distributed resources to provide frequency support services when the forecast indicates potential supply-demand imbalances that could affect grid frequency), Peak Shaving (e.g., the edge device may coordinate multiple energy storage resources to reduce aggregate peak demand at the transformer level when high demand periods are forecasted), Communication and Alerting Actions Utility Notifications (e.g., the system may transmit forecasting results and recommended actions to utility control centers to enable coordinated response across multiple network locations), Customer Communications (e.g., the edge device may send notifications to customers about optimal energy usage periods or participation opportunities in demand response programs), Maintenance Scheduling (e.g., when forecasts indicate periods of low demand or high distributed generation, the system may recommend optimal timing for maintenance activities that require equipment outages), Preventive Actions Equipment Protection (e.g., the system may preemptively adjust operations to prevent transformer overloading or other equipment stress when high demand periods are forecasted), Power Quality Management (e.g., the edge device may coordinate distributed resources to maintain power quality parameters within acceptable ranges during predicted challenging operating conditions). These actions may be implemented automatically within predetermined parameters or may require operator approval depending on the specific system configuration and utility operating procedures. This distributed approach to power management may enable more responsive and efficient electrical grid operations compared to traditional centralized control systems. The artificial intelligence models may utilize various machine learning techniques to process electrical measurement data and generate predictive insights and modified forms of the measurement data that enhance system understanding and control capabilities. In some cases, modifying forms of the measurement data may include directly compressing the measurement data, using mathematical techniques to compress the measurement data, or generating predictive samples of measurement data.

The data compression techniques may include lossless compression methods such as Huffman coding, arithmetic coding, or run-length encoding that preserve all original measurement information while reducing storage and transmission requirements. Mathematical compression techniques may involve principal component analysis (PCA), discrete cosine transform (DCT), or wavelet transform methods that identify and retain the most significant data components while eliminating redundant or less critical information. Predictive sampling may generate synthetic measurement data points based on learned patterns from historical data, enabling the artificial intelligence model to fill gaps in measurement sequences, extrapolate future data points, or create representative datasets for training purposes. These modified data forms may enable more efficient processing, improved pattern recognition, and enhanced forecasting accuracy while maintaining the essential characteristics needed for effective power management decisions within the electrical distribution network.

In some cases, these models may be trained to recognize patterns in electrical consumption and generation data, allowing the edge devices to anticipate future electrical demand and supply conditions. The models may incorporate historical data, real-time measurements, and environmental factors to generate accurate forecasts that inform power management decisions. Additionally, the artificial intelligence models may be configured to continuously learn and adapt their predictive capabilities based on new data inputs and changing conditions within the electrical distribution network.

Edge-based artificial intelligence systems may offer advantages in terms of response time and data processing efficiency for electrical grid management applications. In some cases, by processing data locally at edge devices rather than transmitting all information to centralized systems, the overall system latency may be reduced, enabling faster response to changing electrical conditions. The distributed processing approach may also reduce the computational burden on central systems and minimize the amount of data that needs to be transmitted across communication networks. Furthermore, edge devices with artificial intelligence capabilities may continue to operate and make localized decisions even when communication with central systems is temporarily unavailable, providing enhanced system resilience.

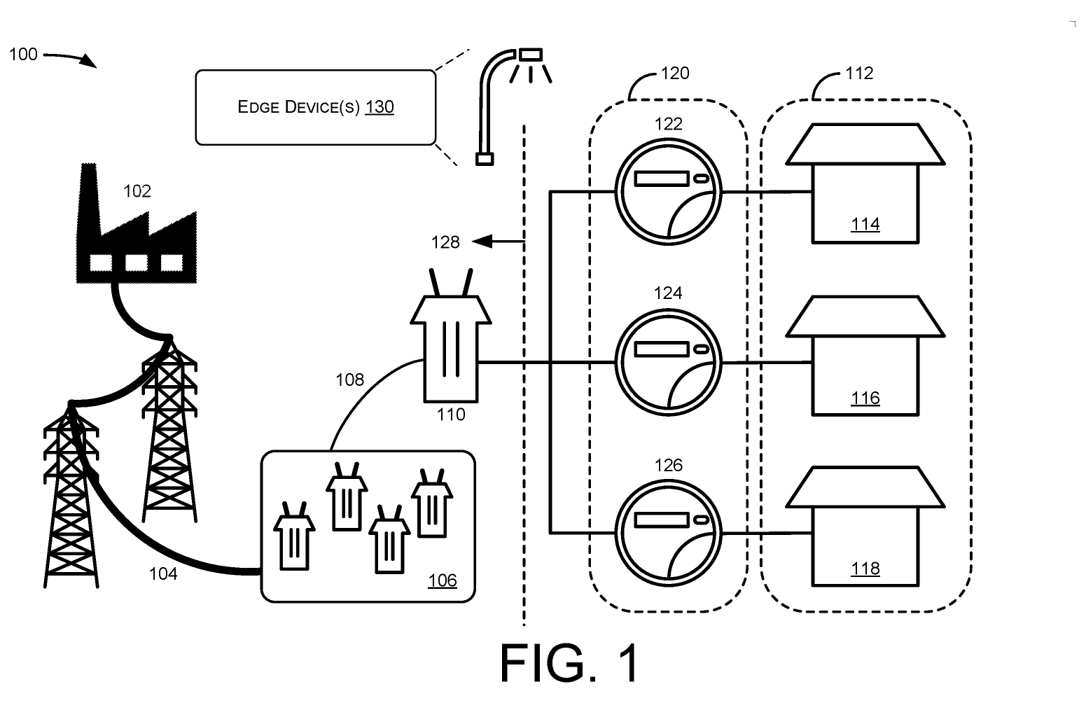

Referring to FIG. 1, a power distribution environment 100 may provide a comprehensive system for generating, transmitting, and distributing electrical power to various consumption points. The power distribution environment 100 may include multiple interconnected components that work together to deliver electricity from generation sources to end users. In some cases, the power distribution environment 100 may be configured to handle varying electrical loads and demands throughout different time periods while maintaining system stability and reliability. The power distribution environment 100 may incorporate both traditional centralized generation sources and distributed energy resources to meet electrical demand requirements.

A power plant 102 may serve as a primary electricity generation source within the power distribution environment 100. The power plant 102 may generate electrical power using various energy sources including fossil fuels, hydroelectric systems, nuclear reactors, and renewable energy sources such as wind and solar installations. In some cases, the power plant 102 may be configured to produce electrical power at specific voltage and frequency levels suitable for transmission through the electrical distribution network. The power plant 102 may include multiple generation units that can be operated individually or in combination to meet varying electrical demand conditions. The electrical output from the power plant 102 may be conditioned and prepared for transmission to downstream distribution components.

Transmission lines 104 may carry electrical power from the power plant 102 to various distribution points within the power distribution environment 100. The transmission lines 104 may operate at high voltage levels to enable efficient long-distance power transmission with reduced electrical losses. In some cases, the transmission lines 104 may be configured as overhead conductors supported by transmission towers or as underground cables depending on geographical and environmental considerations. The transmission lines 104 may incorporate various protective and monitoring equipment to detect fault conditions and maintain system reliability. Multiple transmission lines 104 may be employed to provide redundancy and ensure continued power delivery even when individual transmission paths experience outages or maintenance requirements.

A power substation 106 may receive electrical power from the transmission lines 104 and provide voltage transformation and distribution functions within the power distribution environment 100. The power substation 106 may include transformers, switchgear, protective relays, and control equipment configured to manage electrical power flow and maintain system protection. In some cases, the power substation 106 may step down transmission voltage levels to intermediate distribution voltage levels suitable for local area distribution. The power substation 106 may also provide isolation and switching capabilities that enable maintenance operations and fault isolation within the electrical distribution network. Various monitoring and communication equipment within the power substation 106 may provide operational data and enable remote control capabilities for system operators.

A feeder 108 may extend from the power substation 106 to distribute electrical power to localized areas within the power distribution environment 100. The feeder 108 may comprise individual powered conductors configured to carry electrical current at distribution voltage levels to multiple consumption points. In some cases, the feeder 108 may be designed to handle specific load capacities and may include protective equipment such as circuit breakers and reclosers to isolate fault conditions. The feeder 108 may serve multiple downstream components and may be configured with switching capabilities that enable load transfer and system reconfiguration during maintenance or emergency conditions. Various sensors and monitoring equipment along the feeder 108 may provide real-time data regarding electrical flow, voltage levels, and system conditions.

A transformer 110 may be connected to the feeder 108 to provide voltage transformation between distribution voltage levels and utilization voltage levels suitable for end-user consumption. The transformer 110 may step down electrical voltage from distribution levels to standard utilization voltages used by residential, commercial, and industrial customers. In some cases, the transformer 110 may be configured as a distribution transformer serving multiple premises or as a dedicated transformer for individual large customers. The transformer 110 may include various protective features such as fuses, surge arresters, and monitoring equipment to detect abnormal operating conditions. The electrical output from the transformer 110 may be distributed through secondary conductors to individual service connections.

A premises group 112 may be served by the transformer 110 and may include multiple individual premises that consume electrical power within the power distribution environment 100. The premises group 112 may comprise a first premises 114, a second premises 116, and a third premises 118, each representing individual electrical service locations. In some cases, the premises group 112 may include residential premises, commercial premises, and electric vehicle supply equipment. Each premises within the premises group 112 may have distinct electrical load characteristics and consumption patterns that vary based on occupancy, equipment usage, and operational schedules. The premises group 112 may be configured to receive electrical power from the transformer 110 through individual service connections that provide appropriate voltage and current capacity for each premises.

Metering devices 120 may be associated with the premises group 112 to measure and record electrical consumption at individual service locations within the power distribution environment 100. The metering devices 120 may include a first electricity meter 122 associated with the first premises 114, a second electricity meter 124 associated with the second premises 116, and a third electricity meter 126 associated with the third premises 118. In some cases, the metering devices 120 may be configured to measure various electrical parameters including energy consumption, demand levels, power factor, and voltage conditions. The metering devices 120 may incorporate communication capabilities that enable remote data collection and monitoring of electrical usage patterns. Data collected by the metering devices 120 may be used for billing purposes, load analysis, and system planning activities.

An electrical grid 128 may encompass the interconnected components of the power distribution environment 100 including the power plant 102, power substation 106, transmission lines 104, and other electrical infrastructure elements. The electrical grid 128 may provide the overall framework for electrical power generation, transmission, and distribution within the power distribution environment 100. In some cases, the electrical grid 128 may extend beyond the components shown in FIG. 1 to include additional generation sources, transmission facilities, and distribution networks that collectively form a larger electrical system. The electrical grid 128 may incorporate various control and protection systems that maintain system stability, reliability, and power quality. Interconnections within the electrical grid 128 may enable power sharing between different areas and provide backup power sources during equipment outages or maintenance periods.

An edge device 130 may be positioned within the power distribution environment 100 to provide enhanced computational and communication capabilities for localized power management operations. The edge device 130 may be implemented as a pole mounted router (PMR), connected grid router (CGR), or mains powered device (MPD) depending on specific deployment requirements and environmental conditions. In some cases, the edge device 130 may be configured with greater processing power than the metering devices 120 to enable advanced data analysis and decision-making functions at distributed locations throughout the electrical distribution network. The edge device 130 may be coupled to various objects within the power distribution environment 100 including streetlight, transformer, utility meter, manhole, fire hydrant, power pole, telephone pole, relay, traffic light, parking meter, building, bridge, overpass, street sign, charging station, bus stop, weather station, mailbox, collection bin, or tree structures. The positioning of the edge device 130 on existing infrastructure may provide convenient access to electrical power sources and communication pathways while minimizing additional installation requirements.

The edge device 130 may be configured to communicate with multiple components within the power distribution environment 100 including the metering devices 120, the transformer 110, and various distributed energy resources that may be present at individual premises within the premises group 112. In some cases, the edge device 130 may establish communication links with the first electricity meter 122, second electricity meter 124, and third electricity meter 126 to collect real-time electrical measurement data from each service location. The edge device 130 may also interface with control systems associated with the transformer 110 and other distribution equipment to enable coordinated power management actions (e.g., conflict resolution when multiple edge devices make competing decisions, synchronization mechanisms between edge devices, fallback procedures when coordination fails, etc.). Communication capabilities of the edge device 130 may extend to central utility systems and other edge devices within the electrical grid 128 to facilitate information sharing and coordinated control operations across multiple network locations.

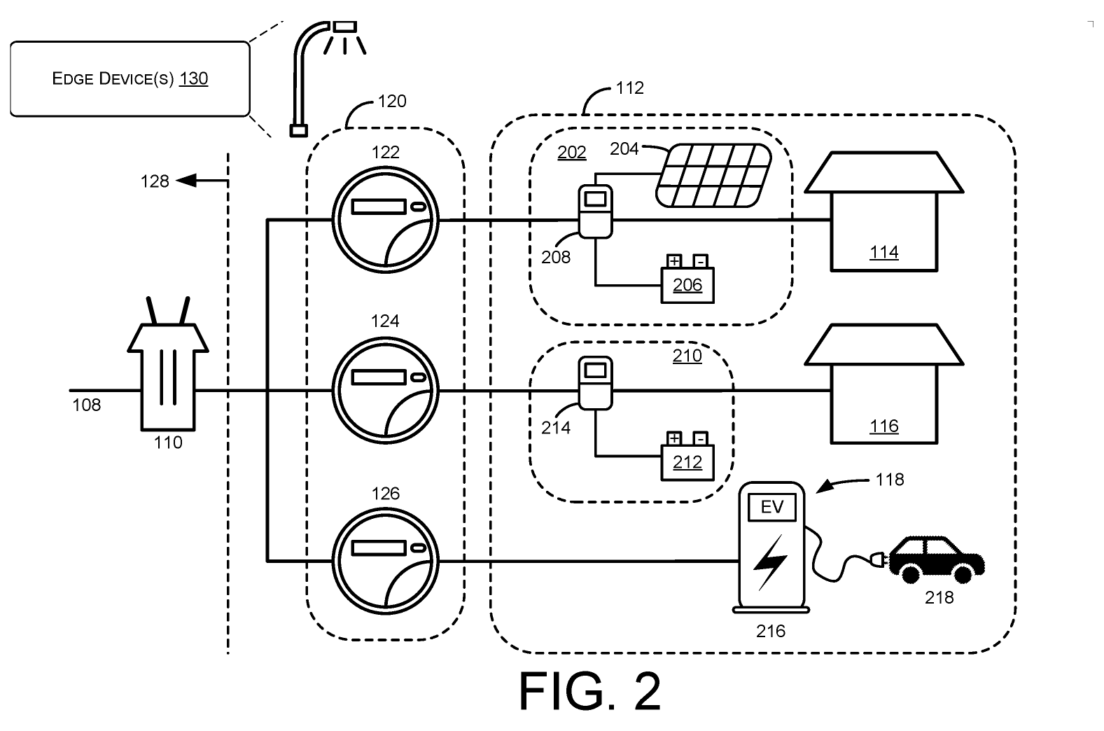

Referring to FIG. 2, the premises group 112 may be equipped with various distributed generation systems that provide localized electrical power generation and storage capabilities within the power distribution environment 100. These distributed generation systems may enable individual premises to generate electrical power from renewable energy sources, store electrical energy for later use, and provide bidirectional power flow capabilities that support both local consumption and grid-connected operations. In some cases, the distributed generation systems may be configured to operate autonomously or under coordinated control to optimize electrical power utilization and support overall grid stability. The integration of distributed generation systems within the premises group 112 may provide enhanced energy resilience and enable participation in demand response programs and grid support services.

The first premises 114 may include a photovoltaic system 202 configured to generate electrical power from solar energy and provide energy storage capabilities for the first premises 114. The photovoltaic system 202 may comprise multiple interconnected components that work together to capture solar energy, convert the energy to electrical power, and manage power distribution between local consumption, energy storage, and grid interconnection functions. In some cases, the photovoltaic system 202 may be sized and configured to meet a portion or all of the electrical energy requirements of the first premises 114 depending on available solar resources, energy consumption patterns, and system design parameters. The photovoltaic system 202 may incorporate monitoring and control capabilities that enable optimization of power generation and energy management functions based on varying solar conditions and electrical demand requirements.

A solar power panel 204 may be incorporated within the photovoltaic system 202 to convert solar radiation into direct current electrical power. The solar power panel 204 may comprise multiple photovoltaic cells arranged in series and parallel configurations to achieve desired voltage and current output characteristics. In some cases, the solar power panel 204 may be mounted on rooftop surfaces, ground-mounted structures, or other suitable locations that provide optimal solar exposure throughout daylight hours. The solar power panel 204 may include bypass diodes and protective components that maintain power generation capabilities even when individual cells or sections experience shading or other performance limitations. The electrical output from the solar power panel 204 may vary based on solar irradiance levels, ambient temperature conditions, and seasonal variations in solar availability.

A photovoltaic battery module 206 may be included within the photovoltaic system 202 to provide electrical energy storage capabilities for the first premises 114. The photovoltaic battery module 206 may comprise multiple battery cells or battery packs configured to store electrical energy generated by the solar power panel 204 during periods of excess generation and release stored energy during periods of insufficient solar generation or increased electrical demand. In some cases, the photovoltaic battery module 206 may utilize lithium-ion, lead-acid, or other battery technologies that provide appropriate energy density, cycle life, and performance characteristics for residential or commercial energy storage applications. The photovoltaic battery module 206 may include battery management systems that monitor cell voltages, temperatures, and state of charge conditions to ensure safe and efficient battery operation throughout the expected service life.

A first inverter 208 may be connected within the photovoltaic system 202 to provide power conversion and energy management functions for the first premises 114. The first inverter 208 may convert direct current electrical power generated by the solar power panel 204 into alternating current electrical power suitable for consumption by electrical loads within the first premises 114 or for interconnection with the electrical grid 128. In some cases, the first inverter 208 may incorporate bidirectional power conversion capabilities that enable charging of the photovoltaic battery module 206 from solar generation or grid sources and discharging of stored energy from the photovoltaic battery module 206 to local loads or grid interconnection points. The first inverter 208 can direct electricity generated by the solar power panel 204 to the first premises 114 for consumption, to the photovoltaic battery module 206 for storage, and/or to the electrical grid 128 depending on instantaneous power generation levels, local electrical demand, and energy management control algorithms.

The first inverter 208 can direct stored electricity from the photovoltaic battery module 206 to the first premises 114 during power outages or to the electrical grid 128 during peak demand periods when grid support services may be beneficial or economically advantageous. In some cases, the first inverter 208 may be configured to provide backup power capabilities that maintain electrical service to designated loads within the first premises 114 during utility power outages or grid disturbances. The first inverter 208 may also participate in grid support functions by providing stored energy to the electrical grid 128 during periods of high electrical demand when additional generation resources are needed to maintain system stability. The first inverter 208 may be configured to stabilize voltage via reactive power injection at times of voltage sag, providing power quality support functions that benefit both local electrical loads and the broader electrical grid 128.

With continued reference to FIG. 2, the second premises 116 may include a battery backup system 210 configured to provide electrical energy storage and backup power capabilities without integrated renewable energy generation. The battery backup system 210 may be designed to store electrical energy obtained from the electrical grid 128 during periods of low electrical demand or favorable electricity pricing and provide stored energy during periods of high demand, power outages, or peak pricing conditions. In some cases, the battery backup system 210 may be configured to participate in utility demand response programs that provide economic incentives for load shifting and grid support services. The battery backup system 210 may incorporate automated control functions that optimize energy storage and discharge operations based on time-of-use electricity rates, demand charge management, and backup power requirements.

A backup battery module 212 may be included within the battery backup system 210 to provide electrical energy storage capabilities for the second premises 116. The backup battery module 212 may comprise battery cells or battery packs configured to store electrical energy received from the electrical grid 128 and release stored energy to electrical loads within the second premises 116 or back to the electrical grid 128 as needed. In some cases, the backup battery module 212 may be sized to provide several hours of backup power for designated loads within the second premises 116 during utility power outages or to provide peak demand reduction capabilities during periods of high electrical consumption. The backup battery module 212 may utilize battery technologies that provide appropriate energy capacity, power output capabilities, and cycle life characteristics for stationary energy storage applications.

A second inverter 214 may be incorporated within the battery backup system 210 to provide power conversion and energy management functions for the second premises 116. The second inverter 214 may convert alternating current electrical power from the electrical grid 128 to direct current power for charging the backup battery module 212 and convert direct current power from the backup battery module 212 to alternating current power for local consumption or grid interconnection. In some cases, the second inverter 214 may direct electricity from the electrical grid 128 to the backup battery module 212 for storage during scheduled time periods corresponding to non-peak hours when electricity rates may be lower or when grid loading conditions are favorable for energy storage operations. The second inverter 214 may also direct stored electricity from the backup battery module 212 to the second premises 116 during power outages or to the electrical grid 128 during peak demand periods when grid support services may provide economic or operational benefits.

As further shown in FIG. 2, the third premises 118 may comprise an electric vehicle supply equipment 216 configured to provide electrical charging capabilities for electric vehicles and potentially bidirectional power flow capabilities that enable vehicle-to-grid energy services. The electric vehicle supply equipment 216 may be designed to safely and efficiently transfer electrical energy between the electrical grid 128 and electric vehicle battery systems while providing appropriate control, monitoring, and safety functions. In some cases, the electric vehicle supply equipment 216 may incorporate communication capabilities that enable coordination with utility systems, electric vehicle management systems, and other distributed energy resources within the power distribution environment 100. The electric vehicle supply equipment 216 may support various charging power levels and charging protocols to accommodate different types of electric vehicles and charging requirements.

An electric vehicle 218 may be connected to the electric vehicle supply equipment 216 to receive electrical charging services and potentially provide stored energy back to the electrical grid 128 during periods when vehicle-to-grid services are requested or beneficial. The electric vehicle 218 may include battery systems that store electrical energy for vehicle propulsion and may also serve as distributed energy storage resources when the electric vehicle 218 is connected to the electric vehicle supply equipment 216. In some cases, the electric vehicle 218 may incorporate communication and control systems that enable coordination with the electric vehicle supply equipment 216 and external energy management systems to optimize charging schedules and energy utilization patterns. The electric vehicle 218 may remain connected to the electric vehicle supply equipment 216 for extended periods, providing opportunities for managed charging and vehicle-to-grid energy services.

The electric vehicle supply equipment 216 may charge the electric vehicle 218 based on a charging schedule, such as during non-peak hours between 10 pm and 6 am, to take advantage of lower electricity rates and reduced grid loading conditions. In some cases, the electric vehicle supply equipment 216 may charge the electric vehicle 218 at a certain battery charging rate and/or when the cost of electricity is below a preselected cost threshold that provides economic benefits for the vehicle owner or grid operator. The electric vehicle supply equipment 216 may incorporate time-based control functions and electricity rate monitoring capabilities that automatically initiate charging operations when favorable conditions are present. The electric vehicle supply equipment 216 may also direct stored electricity from the electric vehicle 218 batteries to the electrical grid 128 during peak demand periods when additional generation resources are needed to maintain grid stability and when economic incentives are provided for vehicle-to-grid energy services.

Referring to FIG. 1, the edge device 130 may be configured to obtain measurement data from multiple connected devices throughout the power distribution environment 100 to enable comprehensive monitoring and analysis of electrical system conditions. The edge device 130 may establish communication links with the metering devices 120 to collect real-time electrical consumption data from the first electricity meter 122, second electricity meter 124, and third electricity meter 126 associated with the premises group 112. In some cases, the edge device 130 may also interface with monitoring equipment associated with the transformer 110 to obtain voltage levels, current flow measurements, and loading conditions that affect the localized distribution network. The measurement data collection process may operate continuously or at predetermined intervals to maintain current awareness of electrical system status and enable timely detection of changing conditions that may require management actions.

The artificial intelligence model stored within the memory 134 of the edge device 130 may process the collected measurement data to identify patterns, trends, and anomalies that provide insights into current and future electrical system behavior. The artificial intelligence model may analyze historical consumption patterns from the metering devices 120 in combination with real-time measurements to generate forecasts of electrical demand for individual premises within the premises group 112 and aggregate demand levels at the transformer 110. In some cases, the artificial intelligence model may incorporate external data sources such as weather information, time-of-day patterns, and seasonal variations to enhance the accuracy of demand forecasting functions. The processing capabilities of the artificial intelligence model may enable the edge device 130 to generate short-term forecasts covering minutes to hours ahead as well as longer-term predictions extending to days or weeks depending on the specific application requirements and available historical data.

With continued reference to FIG. 1, the edge device 130 may utilize the forecasting results generated by the artificial intelligence model to determine appropriate actions for managing electrical supply and demand conditions within the localized area served by the transformer 110. The edge device 130 may compare predicted electrical demand levels with available supply capacity from the electrical grid 128 and identify potential imbalances that could result in voltage deviations, equipment overloading, or service quality issues. In some cases, the edge device 130 may generate control signals or recommendations that are transmitted to controllable devices within the power distribution environment 100 to proactively address anticipated supply and demand imbalances before adverse conditions develop. The action determination process may consider multiple factors including system reliability requirements, economic optimization objectives, and regulatory constraints that govern electrical system operations.

Referring to FIG. 2, the edge device 130 may coordinate with the distributed generation systems located at the premises group 112 to optimize electrical supply and demand management through coordinated control of generation, storage, and consumption resources. The edge device 130 may communicate with the photovoltaic system 202 at the first premises 114 to obtain information regarding current solar power generation levels from the solar power panel 204 and energy storage status of the photovoltaic battery module 206. The artificial intelligence model within the edge device 130 may process this information along with weather forecasts and historical solar generation patterns to predict future power generation capabilities and determine optimal charging and discharging schedules for the photovoltaic battery module 206. In some cases, the edge device 130 may direct the first inverter 208 to adjust power flow between the solar power panel 204, photovoltaic battery module 206, first premises 114, and electrical grid 128 based on the forecasting results and system optimization objectives.

The coordination between the edge device 130 and the battery backup system 210 at the second premises 116 may enable strategic energy storage and discharge operations that support both local and grid-wide electrical management objectives. The edge device 130 may monitor the state of charge and availability of the backup battery module 212 and incorporate this information into supply forecasting calculations performed by the artificial intelligence model. The edge device 130 may generate control commands for the second inverter 214 to schedule charging operations during periods when electrical demand is low or when excess generation capacity is available from distributed resources within the local area. In some cases, the edge device 130 may coordinate discharge operations from the backup battery module 212 during periods of high electrical demand or when grid support services are needed to maintain system stability and power quality within the power distribution environment 100.

As further shown in FIG. 2, the edge device 130 may manage electric vehicle charging operations through coordination with the electric vehicle supply equipment 216 at the third premises 118 to optimize charging schedules and potentially utilize vehicle-to-grid capabilities for system support functions. The artificial intelligence model within the edge device 130 may analyze historical charging patterns, vehicle connection schedules, and electrical demand forecasts to determine optimal charging times that minimize impacts on the electrical grid 128 while meeting vehicle owner requirements. The edge device 130 may communicate with the electric vehicle supply equipment 216 to implement managed charging schedules that shift charging loads to periods of low electrical demand or high renewable energy generation from distributed resources such as the photovoltaic system 202. In some cases, the edge device 130 may coordinate bidirectional power flow from the electric vehicle 218 through the electric vehicle supply equipment 216 to provide stored energy back to the electrical grid 128 during peak demand periods or emergency conditions when additional generation resources are needed.

The artificial intelligence model may continuously learn and adapt its forecasting and control algorithms based on the measurement data collected from the distributed generation systems and the results of previous control actions implemented by the edge device 130. The machine learning capabilities of the artificial intelligence model may enable improved prediction accuracy over time as more historical data becomes available and as the model identifies correlations and patterns specific to the local electrical system characteristics. In some cases, the artificial intelligence model may adjust its forecasting parameters and control strategies based on seasonal variations, changes in customer behavior patterns, and modifications to the distributed generation systems within the premises group 112. The adaptive learning capabilities may enable the edge device 130 to maintain effective performance even as the electrical system evolves and new distributed energy resources are added or existing resources are modified.

With continued reference to FIG. 2, the edge device 130 may implement coordinated control strategies that consider the interactions between multiple distributed generation systems to achieve system-wide optimization objectives rather than optimizing individual resources in isolation. The artificial intelligence model may analyze the combined capabilities of the photovoltaic system 202, battery backup system 210, and electric vehicle supply equipment 216 to determine control actions that maximize overall system benefits while meeting individual customer requirements and preferences. The edge device 130 may coordinate charging and discharging operations across multiple energy storage resources to provide aggregate capacity for grid support services while maintaining adequate backup power capabilities for individual premises. In some cases, the edge device 130 may implement load balancing strategies that distribute electrical demand across multiple time periods and coordinate generation from distributed resources to minimize peak demand levels at the transformer 110 and reduce stress on upstream electrical grid 128 components.

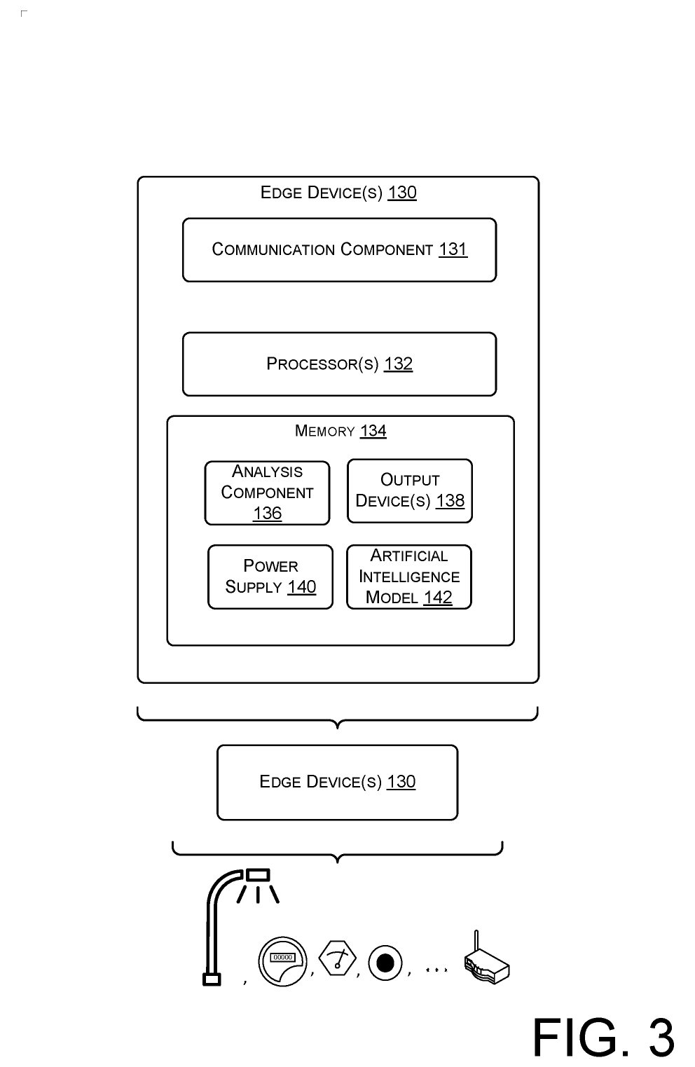

Referring to FIG. 3, the edge device 130 may include various hardware components configured to support data collection, processing, and communication functions within the power distribution environment 100. A communication component 131 may be incorporated within the edge device 130 to enable data exchange with external devices and systems throughout the electrical distribution network. The communication component 131 may support multiple communication protocols and interfaces to accommodate different types of connected devices and varying communication requirements. In some cases, the communication component 131 may include wireless communication capabilities such as cellular, Wi-Fi, or radio frequency interfaces, as well as wired communication options including Ethernet, power line communication, or serial interfaces. The communication component 131 may also incorporate security features and encryption capabilities to protect data transmission and prevent unauthorized access to the edge device 130.

A processor 132 may be included within the communication component 131 to provide computational capabilities for the edge device 130. The processor 132 may be implemented as an application-specific integrated circuit (ASIC), field programmable gate array (FPGA), general purpose microprocessor, microcontroller, system or PC on a chip/card, or other suitable hardware logic components. In some cases, the processor 132 may be configured to execute software applications and algorithms that enable data analysis, pattern recognition, and decision-making functions within the edge device 130. The processor 132 may operate at sufficient computational speeds to handle real-time data processing requirements and generate timely responses to changing electrical conditions within the power distribution environment 100. Multiple processor cores or parallel processing capabilities may be incorporated within the processor 132 to enhance computational performance and enable simultaneous execution of multiple processing tasks.

A memory 134 may be communicatively coupled to the processor 132 to provide data storage and program execution capabilities for the edge device 130. The memory 134 may comprise computer-readable storage media including RAM, ROM, EEPROM, flash memory, cache memory, or other hardware storage devices or hardware-based memory technology. In some cases, the memory 134 may be configured with sufficient capacity to store artificial intelligence models, historical data, configuration parameters, software applications used by the edge device 130, and/or other instructions. The memory 134 may include both volatile and non-volatile storage components to support different data retention requirements and access speed characteristics. Data stored within the memory 134 may include measurement data collected from the metering devices 120, processed analysis results, control parameters used for power management operations, and/or other instructions configured to cause performance of operations described herein.

An analysis component 136 may be stored within the memory 134 to provide data processing and analytical capabilities for the edge device 130. The analysis component 136 may include software algorithms and processing routines configured to analyze electrical measurement data and identify patterns, trends, and anomalies within the collected information. In some cases, the analysis component 136 may incorporate statistical analysis functions, signal processing algorithms, and data filtering capabilities to extract meaningful insights from raw measurement data. The analysis component 136 may work in conjunction with artificial intelligence models stored within the memory 134 to generate predictive forecasts and recommendations for power management actions. Results generated by the analysis component 136 may be used to inform control decisions and trigger appropriate responses to changing electrical conditions within the power distribution environment 100.

In some cases, the analysis component 136 may include an algorithmic function that may represents a statistical algorithmic function, a computational algorithmic function, a machine learning algorithmic function, an AI algorithmic function. In some cases, a combination of analysis and artificial intelligence may include a two-component algorithm: one involved in monitoring and inferring the state of a system, and the other in inference and prediction specifically intended to trigger or guide action based on that state. These two components may each be associated with a pipeline of steps that form a feedback loop between each other. In some cases these could be combined to a single real-time model application

The two-component algorithm architecture may enable enhanced system responsiveness by separating monitoring functions from decision-making functions while maintaining coordinated operation through the feedback loop mechanism. The first component may continuously process measurement data from the metering devices 120 and distributed generation systems to maintain an updated understanding of current electrical system conditions, load patterns, and resource availability. The second component may utilize the state information provided by the first component to generate predictive models and control recommendations that optimize power distribution operations. In some cases, the pipeline of steps within each component may include data preprocessing, feature extraction, pattern recognition, and output generation stages that can be executed in parallel or sequential configurations depending on computational resources and timing requirements. The feedback loop between the two components may enable continuous refinement of both monitoring accuracy and prediction performance as the system learns from the results of implemented control actions and observed system responses.

An output device 138 may be included within the memory 134 to provide data presentation and communication capabilities for the edge device 130. The output device 138 may be configured to format and transmit processed data, analysis results, and control commands to external systems and devices within the electrical distribution network. In some cases, the output device 138 may support multiple output formats and communication protocols to accommodate different receiving systems and data presentation requirements. The output device 138 may generate reports, alerts, and status information that can be transmitted to utility control centers, other edge devices, or local display systems. Data output capabilities of the output device 138 may include real-time streaming of measurement data, periodic transmission of summary reports, and event-driven communication of alarm conditions or control actions.

A power supply 140 may be incorporated within the memory 134 to provide electrical power management functions for the edge device 130. The power supply 140 may be configured to receive electrical power from the electrical grid 128 or from local power sources and condition the power to appropriate voltage and current levels for operation of the edge device 130 components. In some cases, the power supply 140 may include backup power capabilities such as battery systems or capacitive storage to maintain operation during temporary power outages or voltage disturbances. The power supply 140 may also incorporate power monitoring and protection features to detect abnormal power conditions and protect the edge device 130 from electrical damage. Power management functions of the power supply 140 may include voltage regulation, current limiting, and power factor correction to ensure stable and efficient operation of the edge device 130 under varying electrical conditions.

The memory 134 may include machine-learning models and a data log component in addition to the analysis component 136, output device 138, power supply 140, and artificial intelligence model components. The machine-learning models may provide specialized analytical capabilities for specific types of data analysis and pattern recognition tasks within the power distribution environment 100. In some cases, the data log component may maintain historical records of measurement data, analysis results, and control actions performed by the edge device 130. The data log component may support data archival functions and provide access to historical information for trend analysis and system performance evaluation. Integration of multiple software components within the memory 134 may enable the edge device 130 to perform complex data processing and decision-making functions while maintaining organized data management and system operation capabilities.

Referring to FIG. 3, the communication component 131 of the edge device 130 may facilitate bidirectional data exchange with central utility systems and other edge devices within the broader electrical grid 128 to enable coordinated management actions across multiple localized areas. The edge device 130 may transmit forecasting results, system status information, and control action reports to utility control centers to provide visibility into local electrical conditions and distributed resource capabilities. The artificial intelligence model may generate summary reports and exception notifications that highlight significant changes in local electrical conditions or distributed resource performance that may affect broader grid operations. In some cases, the edge device 130 may receive coordination signals and control directives from central utility systems that influence local control decisions and ensure that distributed resource management actions support overall grid stability and reliability objectives.

The processor 132 within the edge device 130 may execute real-time control algorithms that enable rapid response to changing electrical conditions detected through the measurement data collection and analysis functions performed by the artificial intelligence model. The edge device 130 may implement automatic control responses that adjust distributed generation system operations within predetermined parameters and time constraints to address immediate electrical system needs without requiring communication delays associated with central system coordination. The analysis component 136 may continuously monitor the effectiveness of control actions implemented by the edge device 130 and provide feedback to the artificial intelligence model to support ongoing learning and algorithm refinement processes. In some cases, the edge device 130 may maintain backup control capabilities that enable continued operation of distributed resource management functions even when communication with central utility systems is temporarily unavailable due to network outages or maintenance activities.

The output device 138 may generate various types of reports and notifications that communicate the results of artificial intelligence model analysis and control actions to different stakeholders within the electrical system operation and management structure. The edge device 130 may produce real-time dashboards and status displays that provide utility operators with visibility into local electrical conditions, distributed resource performance, and forecasting results generated by the artificial intelligence model. The edge device 130 may also generate customer notifications and reports that inform distributed resource owners about system performance, energy savings achieved through coordinated control actions, and participation in grid support services. In some cases, the output device 138 may format data for integration with utility billing systems, regulatory reporting requirements, and performance measurement programs that track the effectiveness of distributed resource management and grid modernization initiatives implemented through edge-based artificial intelligence systems.

With continued reference to FIG. 3, an artificial intelligence model 142 may be stored within the memory 134 to provide advanced data analysis and predictive capabilities for the edge device 130. The artificial intelligence model 142 may be configured to process measurement data collected from various sources within the power distribution environment 100 and generate forecasts, recommendations, and control decisions based on the analyzed information. In some cases, the artificial intelligence model 142 may utilize machine learning techniques to identify patterns in electrical consumption and generation data, enabling the edge device 130 to anticipate future electrical demand and supply conditions with enhanced accuracy. The artificial intelligence model 142 may be trained using historical data from the power distribution environment 100 and may continuously adapt and improve performance based on new data inputs and changing operational conditions. The deployment of the artificial intelligence model 142 on the edge device 130 may enable localized decision-making capabilities that reduce response times and enhance system responsiveness compared to centralized processing approaches.

The artificial intelligence model 142 may incorporate various machine learning algorithms to address different aspects of electrical power management and data analysis within the power distribution environment 100. Regression algorithms may be implemented within the artificial intelligence model 142 to establish relationships between input variables and output predictions, enabling forecasting of electrical demand, generation levels, and system parameters based on historical trends and current conditions. In some cases, regression algorithms may include ordinary least squares regression (OLSR), linear regression, logistic regression, stepwise regression, multivariate adaptive regression splines (MARS), and locally estimated scatterplot smoothing (LOESS) techniques that provide different approaches to modeling relationships within electrical measurement data. Instance-based algorithms may be utilized within the artificial intelligence model 142 to make predictions based on similarity to historical data points, including ridge regression, least absolute shrinkage and selection operator (LASSO), elastic net, and least-angle regression (LARS) methods that provide regularization and feature selection capabilities for complex datasets.

Decision tree algorithms may be incorporated within the artificial intelligence model 142 to provide rule-based decision-making capabilities that can be interpreted and understood by system operators and maintenance personnel. The decision tree algorithms may include classification and regression tree (CART), iterative dichotomiser 3 (ID3), Chi-squared automatic interaction detection (CHAID), decision stump, and conditional decision trees that enable hierarchical decision structures for power management operations. In some cases, Bayesian algorithms may be implemented within the artificial intelligence model 142 to incorporate probabilistic reasoning and uncertainty quantification into prediction and control functions. Bayesian algorithms may include naïve Bayes, Gaussian naïve Bayes, multinomial naïve Bayes, average one-dependence estimators (AODE), Bayesian belief network (BNN), and Bayesian networks that provide statistical inference capabilities for electrical system analysis and forecasting applications.

Clustering algorithms may be utilized within the artificial intelligence model 142 to identify groups of similar operating conditions, consumption patterns, or system states within the electrical measurement data collected by the edge device 130. The clustering algorithms may include k-means, k-medians, expectation maximization (EM), and hierarchical clustering techniques that enable segmentation of data into meaningful categories for analysis and control purposes. In some cases, association rule learning algorithms may be implemented within the artificial intelligence model 142 to discover relationships and dependencies between different variables and events within the power distribution environment 100. Association rule learning algorithms may include perceptron, back-propagation, hopfield network, and Radial Basis Function Network (RBFN) approaches that identify patterns and correlations in electrical system data that can inform predictive models and control strategies.

Deep learning algorithms may be incorporated within the artificial intelligence model 142 to provide advanced pattern recognition and feature extraction capabilities for complex electrical system data analysis. The deep learning algorithms may include Deep Boltzmann Machine (DBM), Deep Belief Networks (DBN), Convolutional Neural Network (CNN), transformer neural networks, physics constrained algorithms (e.g., Physics Informed Machine Learning or Physics informed Neural Networks), Stacked Auto-Encoders, Recurrent Neural Networks (RNN), Long Short-Term Memory (LSTM), Gated Recurrent Units (GRU), Generative Adversarial Networks (GAN), Variational Autoencoders (VAE), Graph Neural Networks (GNN), Attention Networks, Capsule Networks, and Reinforcement Learning Networks that enable automatic feature learning and hierarchical representation of electrical measurement data. In some cases, dimensionality reduction algorithms may be implemented within the artificial intelligence model 142 to reduce the complexity of high-dimensional datasets while preserving important information for analysis and prediction functions. Dimensionality reduction algorithms may include Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), and Flexible Discriminant Analysis (FDA) techniques that enable efficient processing of large datasets collected from multiple sources within the power distribution environment 100.

Ensemble algorithms may be utilized within the artificial intelligence model 142 to combine multiple individual models and algorithms to achieve enhanced prediction accuracy and robustness compared to single-model approaches. In some cases, the ensemble algorithms may include a purposeful combination of multiple varieties of algorithms to produce a final result (e.g., XGboost and a neural net). The ensemble algorithms may include Boosting, Bootstrapped Aggregation (Bagging), AdaBoost, Stacked Generalization (blending), Gradient Boosting Machines (GBM), Gradient Boosted Regression Trees (GBRT), and Random Forest techniques that leverage the strengths of multiple learning algorithms while mitigating individual model weaknesses. In some cases, support vector machines (SVM) may be implemented within the artificial intelligence model 142 to provide classification and regression capabilities for electrical system data analysis and pattern recognition applications. The artificial intelligence model 142 may incorporate supervised learning, unsupervised learning, and semi-supervised learning approaches depending on the availability of labeled training data and the specific analysis requirements for different power management functions within the edge device 130.

The artificial intelligence model 142 may utilize various neural network architectures to provide specialized capabilities for different types of electrical system analysis and prediction tasks within the power distribution environment 100. Neural network architectures such as ResNet50 and ResNet101 may be implemented within the artificial intelligence model 142 to provide deep residual learning capabilities that enable training of very deep networks while avoiding degradation problems associated with increased network depth. In some cases, ResNeXt101 architectures may be incorporated within the artificial intelligence model 142 to provide enhanced feature representation capabilities through cardinality-based network design that improves model performance for complex pattern recognition tasks. VGG architectures may be utilized within the artificial intelligence model 142 to provide systematic approaches to network depth and feature extraction that enable effective processing of electrical measurement data with varying complexity levels.

DenseNet architectures may be implemented within the artificial intelligence model 142 to provide dense connectivity patterns that enable efficient feature reuse and gradient flow throughout the network structure, potentially reducing the number of parameters while maintaining or improving model performance. In some cases, PointNet architectures may be incorporated within the artificial intelligence model 142 to process unordered sets of data points that may be encountered in electrical system monitoring applications where spatial relationships and geometric structures are relevant to analysis tasks. CenterNet architectures may be utilized within the artificial intelligence model 142 to provide object detection and localization capabilities that may be applicable to identifying and analyzing specific events, anomalies, or patterns within electrical measurement data collected from multiple sources throughout the power distribution environment 100.

Additional processing techniques may be applied in conjunction with the artificial intelligence model 142 to enhance data analysis capabilities and improve the accuracy of predictions and control decisions generated by the edge device 130. Gaussian blurs may be applied to electrical measurement data to reduce noise and smooth variations that may interfere with pattern recognition and trend analysis functions performed by the artificial intelligence model 142. In some cases, Gaussian blur techniques may be particularly useful for processing time-series electrical data that contains high-frequency noise or measurement artifacts that could negatively impact the performance of machine learning algorithms. Bayes Functions may be implemented in combination with the artificial intelligence model 142 to provide probabilistic inference capabilities that enable uncertainty quantification and risk assessment for electrical system predictions and control decisions.

Color analyzing or processing techniques may be applied in conjunction with the artificial intelligence model 142 when electrical measurement data is represented in visual formats such as heat maps, spectrograms, or other graphical representations that encode multiple dimensions of information using color coding schemes. The color analyzing techniques may enable extraction of relevant features and patterns from visual data representations that complement numerical analysis methods implemented within the artificial intelligence model 142. In some cases, combinations of Gaussian blurs, Bayes Functions, and color analyzing techniques may be applied together with the artificial intelligence model 142 to provide comprehensive data processing capabilities that address different aspects of electrical system analysis and enable robust performance under varying operating conditions and data quality scenarios within the power distribution environment 100.

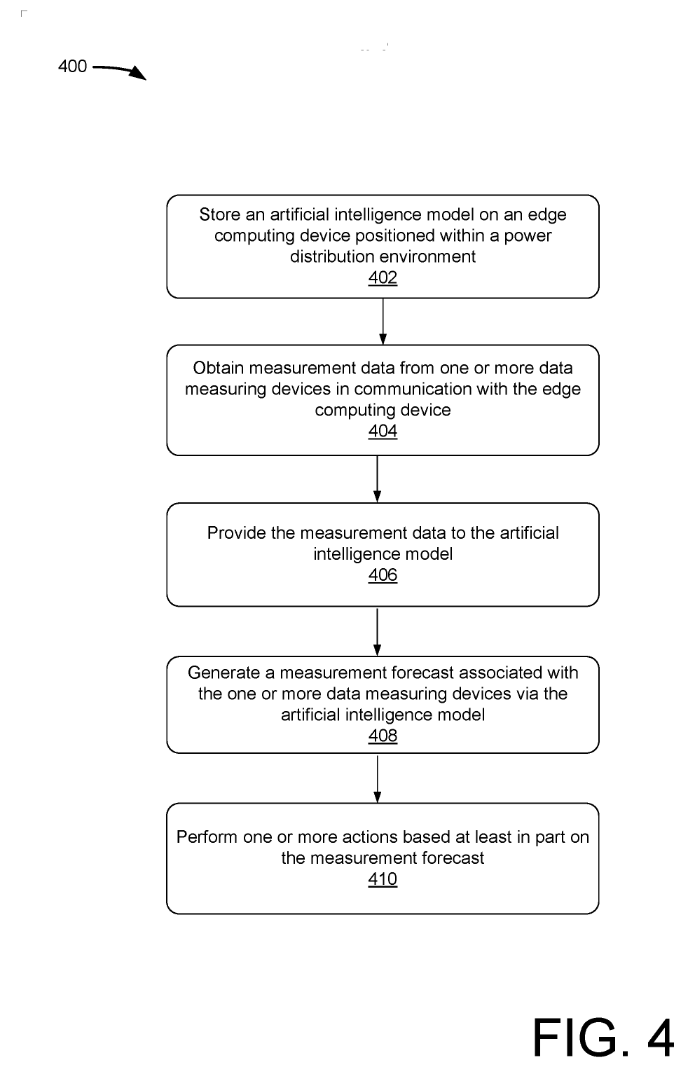

Referring to FIG. 4, a process 400 may provide a systematic approach for implementing artificial intelligence-based electrical power management functions on edge computing devices within power distribution environments. The process 400 may enable edge devices to collect measurement data from distributed sources, analyze the data using machine learning algorithms, generate predictive forecasts, and implement control actions that optimize electrical supply and demand conditions at localized network locations.

At step 402, the process 400 may include storing an artificial intelligence model on an edge computing device positioned within a power distribution environment. The artificial intelligence model may be configured with machine learning algorithms including regression algorithms, decision tree algorithms, clustering algorithms, neural network architectures, and ensemble methods that enable analysis of electrical measurement data and generation of predictive forecasts. In some cases, the artificial intelligence model may be pre-trained using historical electrical system data and deployed to the edge computing device through secure communication channels, enabling localized processing capabilities without requiring continuous connectivity to central systems. In some cases, the artificial intelligence model may be trained using "online learning," wherein the artificial intelligence model updates (e.g., “learns") in real time based on streaming data upon which it makes predictions, taking in feedback about the accuracy of the predictions and/or impact of the actions resulting from the predictions. For example, a combination of analysis and artificial intelligence may include a two-component algorithm: one involved in monitoring and inferring the state of a system, and the other in inference and prediction specifically intended to trigger or guide action based on that state. These two components may each be associated with a pipeline of steps that form a feedback loop between each other. In some cases these could be combined to a single real-time model application.

At step 404, the process 400 may include obtaining measurement data from one or more data measuring devices in communication with the edge computing device. The measurement data may comprise electrical consumption information from electricity metering devices associated with multiple premises, generation data from distributed energy resources such as photovoltaic systems and battery storage systems, and operational parameters from electrical distribution equipment including transformers and switching devices. In some cases, the edge computing device may establish communication links with the data measuring devices using various protocols including wireless communication, power line communication, or wired interfaces to enable continuous or periodic data collection from multiple sources within the power distribution network.

At step 406, the process 400 may include providing the measurement data to the artificial intelligence model for processing and analysis. The measurement data may be formatted and preprocessed to ensure compatibility with the input requirements of the artificial intelligence model, including data normalization, filtering, and feature extraction operations that enhance the quality and relevance of the information provided to the machine learning algorithms. In some cases, the artificial intelligence model may process the measurement data in combination with external information sources such as weather forecasts, time-of-day patterns, and historical consumption trends to generate comprehensive analysis results that account for multiple factors affecting electrical system behavior.

At step 408, the process 400 may include generating a measurement forecast associated with the one or more data measuring devices via the artificial intelligence model. The measurement forecast may comprise or indicate predictions of electrical demand levels for individual premises and aggregate demand at distribution transformers, forecasts of generation output from distributed energy resources, and estimates of system loading conditions over various time horizons ranging from minutes to days ahead. In some cases, the artificial intelligence model may generate multiple forecast scenarios with associated confidence levels and uncertainty bounds that enable risk assessment and robust decision-making for electrical system management applications.

At step 410, the process 400 may include performing one or more actions based at least in part on the measurement forecast generated by the artificial intelligence model. The actions may comprise transmitting control signals to distributed energy resources to adjust charging and discharging operations, generating recommendations for load management and demand response programs, and providing forecasting results and system status information to utility control centers and other stakeholders. In some cases, the edge computing device may implement automatic control responses that optimize electrical supply and demand conditions within predetermined parameters while maintaining system reliability and meeting customer service requirements throughout the power distribution environment.

A number of implementations have been described. Nevertheless, it will be understood that various modifications may be made without departing from the spirit and scope of the disclosure. Accordingly, other implementations are within the scope of the following claims.

1. A method comprising:
storing an artificial intelligence model on an edge computing device positioned within a power distribution environment;
obtaining measurement data from one or more data measuring devices in communication with the edge computing device;
providing the measurement data to the artificial intelligence model;
generating a measurement forecast associated with the one or more data measuring devices via the artificial intelligence model; and
performing one or more actions based at least in part on the measurement forecast.

2. The method of claim 1, further comprising:
determining a predicted demand for electricity associated with a plurality of premises connected to an electrical grid based at least in part on the measurement forecast, the plurality of premises including a distributed generation system associated with one of the plurality of premises;
determining available electricity supply for the plurality of premises;
comparing the predicted demand with the available electricity supply; and
in response to determining that the predicted demand exceeds a first predetermined amount of the available electricity supply, reducing a charging load of an electric vehicle supply equipment.

3. The method of claim 2, wherein the distributed generation system comprises at least one of:
a photovoltaic system including a solar power panel and a photovoltaic battery module;
a battery backup system including a backup battery module; or
an electric vehicle supply equipment configured to provide bidirectional power flow.

4. The method of claim 1, wherein obtaining the measurement data includes receiving electricity usage data from a plurality of premises that includes receiving at least one of:
electricity metering devices associated with the plurality of premises;
a distributed generation system;
electric vehicle telematics of an electric vehicle connected to an electrical grid; or
an electric vehicle supply equipment associated with the electrical grid.

5. The method of claim 4, wherein the electricity usage data includes:
present electricity consumption data associated with the plurality of premises;
historical electricity consumption data associated with the plurality of premises;
present electricity generation data associated with the distributed generation system; and
historical electricity generation data associated with the distributed generation system.

6. The method of claim 1, wherein performing the one or more actions comprises at least one of Load Management Actions Electric Vehicle Charging Control, Battery Storage Operations, Demand Response Activation, Generation Resource Coordination Distributed Generation Optimization, , Reactive Power Management, Generation Curtailment, Grid Support Functions Voltage Regulation , Frequency Response, Peak Shaving, Communication and Alerting Actions Utility Notifications, Customer Communications, Maintenance Scheduling, Preventive Actions Equipment Protection, or Power Quality Management.

7. The method of claim 1, wherein the measurement forecast indicates at least one of:
a demand level at a transformer associated with a plurality of premises; and
a supply level available at the transformer.

8. The method of claim 1, further comprising:
generating at least one of an estimated current state or an estimated current consumption based at least in part on providing the measurement data to the artificial intelligence model.

9. The method of claim 2, further comprising:
in response to determining that the predicted demand is lower than a second predetermined amount of the available electricity supply, increasing a charging load of the electric vehicle supply equipment.

10. The method of claim 9, wherein the electric vehicle supply equipment is configured to charge an electric vehicle based on a charging schedule corresponding to non-peak hours when electricity rates are below a preselected cost threshold.

11. An edge computing device comprising:
one or more processors; and
memory communicatively coupled to the one or more processors, the memory storing thereon computer executable instructions that, when executed by the one or more processors, cause the one or more processors to perform operations comprising:
storing an artificial intelligence model on the edge computing device;
obtaining measurement data from one or more electricity metering devices associated with a plurality of premises connected to an electrical grid;
providing the measurement data to the artificial intelligence model;
generating a measurement forecast associated with electrical demand or supply via the artificial intelligence model; and
transmitting control signals to one or more distributed energy resources based at least in part on the measurement forecast.

12. The edge computing device of claim 11, wherein the one or more distributed energy resources comprise at least one of:
a photovoltaic system including a solar power panel and a photovoltaic battery module;
a battery backup system including a backup battery module; or
an electric vehicle supply equipment configured to provide bidirectional power flow with an electric vehicle.

13. The edge computing device of claim 12, wherein the operations further comprise:
determining a predicted demand for electricity associated with the plurality of premises based at least in part on the measurement forecast;
comparing the predicted demand with available electricity supply; and
in response to determining that the predicted demand exceeds a predetermined threshold, transmitting control signals to reduce charging load of the electric vehicle supply equipment.

14. The edge computing device of claim 13, wherein the operations further comprise:
in response to determining that the predicted demand is below a second predetermined threshold, transmitting control signals to increase the charging load of the electric vehicle supply equipment during non-peak hours.

15. The edge computing device of claim 11, wherein the artificial intelligence model comprises at least one of:
a machine learning algorithm selected from regression algorithms, decision tree algorithms, clustering algorithms, or neural network algorithms;
a deep learning algorithm including convolutional neural networks or deep belief networks; or
an ensemble algorithm including random forest or gradient boosting machines.

16. The edge computing device of claim 11, wherein the edge computing device is configured as one of a pole mounted router, a connected grid router, or a mains powered device coupled to infrastructure selected from a streetlight, transformer, utility meter, power pole, or charging station within the electrical grid.

17. A power distribution system comprising:
a transformer connected to a feeder and configured to serve a plurality of premises;
a plurality of electricity metering devices associated with the plurality of premises;
an edge computing device in communication with the plurality of electricity metering devices, the edge computing device including an artificial intelligence model configured to process measurement data from the plurality of electricity metering devices and generate forecasts of electrical demand; and
at least one distributed energy resource associated with one of the plurality of premises, wherein the edge computing device is configured to coordinate operation of the at least one distributed energy resource based on the forecasts of electrical demand.

18. The power distribution system of claim 17, wherein the at least one distributed energy resource comprises:
a photovoltaic system including a solar power panel and a photovoltaic battery module with a first inverter configured to direct electricity between the solar power panel, the photovoltaic battery module, one of the plurality of premises, and an electrical grid.

19. The power distribution system of claim 18, wherein the edge computing device is further configured to:
determine a predicted demand for electricity associated with the plurality of premises based at least in part on the forecasts of electrical demand;
compare the predicted demand with available electricity supply from the electrical grid; and
transmit control signals to the first inverter to direct stored electricity from the photovoltaic battery module to the electrical grid during peak demand periods.

20. The power distribution system of claim 19, wherein the artificial intelligence model is configured to continuously learn and adapt forecasting algorithms based on measurement data collected from the plurality of electricity metering devices and results of previous control actions, and wherein the edge computing device is positioned as one of a pole mounted router, connected grid router, or mains powered device coupled to infrastructure within the power distribution system.
